(19) United States
(12) Patent Application Publication
(10) Pub. No.: US 2009/0034068 A1
(43) Pub. Date: Feb. 5, 2009

(54) Viewing apparatus

(76) Inventors: Frederic McCurdy, Newburgh, NY (US); Louis N. Chappo, Newburgh, NY (US); Raymond Kallio, New Paltz, NY (US)

Correspondence Address: FULBRIGHT & JAWORSKI, LLP, 666 FIFTH AVE, NEW YORK, NY, 10103-3198, US

(21) Appl. No.: 11/888,101

(22) Filed: Jul. 31, 2007

(51) Int. Cl. G03B 21/56

(52) U.S. Cl. 359/443

(57) ABSTRACT

An illumination station for viewing reflection copy images such as documents, photos, and the like having a back-plate against which a reflection copy image is disposed for viewing, one or more overhead light sources disposed in a top member, and a reflector at the base of the back-plate configured to reflect incident light on the lower portion of the back-plate. The use of a reflector provides enhanced illumination to the lower portion of the back-plate and therefore improves the uniformity of illumination of the entire back-plate, and, consequently, of the reflection copy image affixed thereto.

### FIELD OF INVENTION

The present invention relates generally to illuminated stations for viewing reflection copies such as documents, particularly color images, commonly known as light booths. More particularly, the invention is directed to a light booth having improved uniformity of illumination across a viewing region to facilitate a viewer's perception of a reflection copy placed in the viewing region by providing a better lit and more uniformly lit reflection copy image.

### BACKGROUND

Illuminated viewing environments, commonly known as light booths, are well known in the photographic and graphic arts for transmission or reflectance viewing of color prints, proofs, transparencies and the like. Typically, a light booth comprises a back-plate against which a reflection copy image such as a document or photograph, is placed for viewing and an overhead lighting source, such as incandescent, fluorescent, or ultraviolet lamp, for illuminating the document. Such viewing systems have found wide-spread use for visual color assessment, comparison of color variations, color-matching, the detection of metamerism (the detection of slight color differences), and soft-proofing.

One shortcoming of conventional light booths is uneven illumination of the back-plate resulting from the fact that the intensity of light incident is attenuated by the square of the distance from the light source. The function that describes how apparent brightness changes with distance is given by the mathematical relationship:

I=Iₒ/r²

As shown by the formula, the intensity of the light varies as the inverse square of the separation from the light source (r).

As such, because the light source is typically placed towards the top of the back-plate, the brightness of the back-plate will be greater at the top of the back-plate than at the bottom. Such uneven illumination makes accurate color assessment of the entire reflection copy image difficult.

Therefore, there is a need in the art for light booths which overcome the deficiencies of the prior art by providing substantially uniform light intensity across the surface of the back-plate and thus across the reflection copy image disposed thereupon. It is therefore an object of the present invention to provide viewing environments, particularly those known in the art as light booths, for illuminating reflection copies, in particular colored documents such as photographs, which provide improved uniformity of light across the entire viewing region.

### SUMMARY OF THE INVENTION

In accordance with the foregoing objectives and others, the present invention provides illuminated stations for viewing reflection copy images such as documents and the like, having a back-plate against which a reflection copy image is disposed for viewing, one or more overhead light sources disposed in a top member, and a reflector at the base of the back-plate configured to reflect incident light on the lower portion of the back-plate. It has surprisingly been found that the use of a reflector, configured as described herein, provides enhanced illumination to the lower portion of the back-plate and therefore improves the uniformity of illumination of the entire back-plate, and, consequently, of the reflection copy image affixed thereto.

In an embodiment of the present invention, the light booth comprises a back-plate against which a reflection copy image is disposed for viewing; at least one overhead light disposed in a top member of the light booth; and a reflector at a base of the back-plate configured to reflect incident light at the lower portion of the back-plate thereby improving the uniformity of illumination of the back-plate and consequently of the reflection copy disposed thereon.

In an exemplary embodiment of the present invention, the light booth comprises: a back-plate for supporting a reflection copy; a top member having a proximal end and a distal end wherein the proximal end is coupled to the upper end of the back-plate to form an angle in the range of or about 82 to 86 degrees; a base comprising a reflective portion; wherein the reflective portion has a proximal end, a distal end, and a width dimension; wherein the proximal end is coupled to the lower end of the back-plate to form an angle in the range of or about 88 to 92 degrees. The light booth further comprises a first and second overhead light disposed in the top member for illuminating the back-plate; the first and second overhead light disposed such that each optical axis of light incident to the proximal end of the reflective portion has an angle dimension relative to the width dimension sufficient to reflect incident light rays towards a bottom portion of the back-plate, thereby increasing the intensity of light on the bottom portion and improving the overall uniformity of illumination of the back-plate.

These and other features, aspects, and advantages of the present invention will become better understood with reference to the following detailed description, drawings, and appended claims.

### BRIEF DESCRIPTION OF THE DRAWINGS

FIG. 1 is side view of a conventional light booth.

FIG. 2 is a side view of an embodiment of a viewing apparatus in accordance with the present invention.

FIG. 3 is a side view of an embodiment of a viewing apparatus in accordance with an embodiment of the present invention showing exemplary dimensions that maximize the illumination of the bottom portion of a back-plate having a height of or about 35 cm.

FIG. 4 is a side view of an embodiment of a viewing apparatus in accordance with an embodiment of the present invention showing exemplary dimensions that maximize the illumination of the bottom portion of a back-plate having a height of or about 32 cm.

FIG. 5 is a side view of an embodiment of a viewing apparatus in accordance with an embodiment of the present invention showing exemplary dimensions that maximize the illumination of the bottom portion of a back-plate having a height of or about 44 cm.

FIG. 6 is a side view of an embodiment of a viewing apparatus in accordance with an embodiment of the present invention showing exemplary dimensions that maximize the illumination of the bottom portion of a back-plate having a height of or about 62 cm.

FIG. 7 is a frontal view of an embodiment of a viewing apparatus in accordance with the invention.

### DETAILED DESCRIPTION

As used herein, all terms are intended to have their ordinary and accustomed meaning in the art unless otherwise specified. The term “light booth” is not meant to be particularly limiting and refers generally to any apparatus for viewing an object against a vertical or inclined plate in which overhead lighting illuminates the viewing surface.

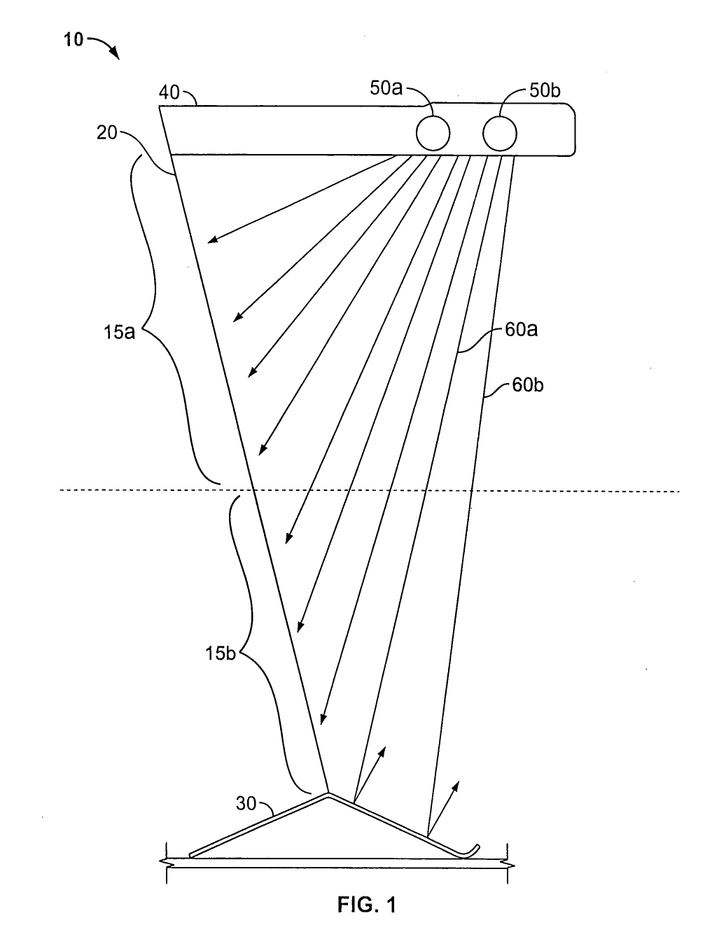

Referring now to FIG. 1, a conventional light booth 10 of the prior art is illustrated. Light booth 10 comprises an inclined back-plate 20 which is mounted on a base 30. A top member 40 houses one or more light sources (shown as 50a and 50b) disposed towards the proximal end 55 of top member 40 in relation to the viewer. This configuration minimizes the distance between light sources 50a and 50b and the top and bottom of back-plate 20. Base 30 is typically inclined away from back-plate 20 so as to form an obtuse angle therewith. In this configuration, some light (e.g. 60a and 60b) incident on the base is reflected away from the viewing surface as shown by the arrows, and therefore, does not illuminate back-plate 20. In practice it has been observed that a substantial gradient in light intensity exists from top half 15a to bottom half 15b of the viewing surface in light booths such as those shown in FIG. 1.

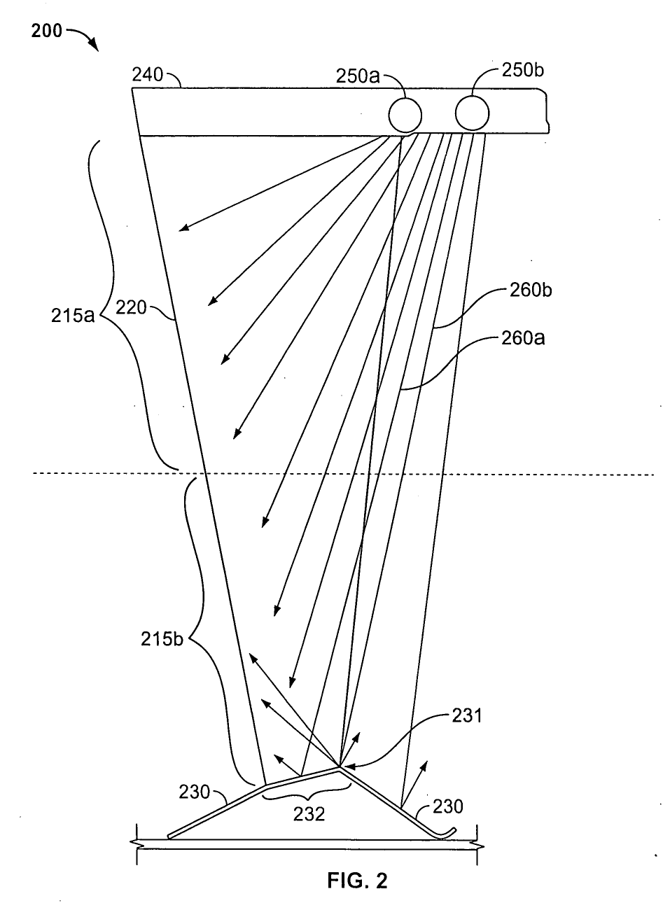

One embodiment of the inventive light booth is shown in FIG. 2. Light booth 200 comprises an inclined back-plate 220 which is mounted on a base 230. A top member 240 houses one or more light sources (shown as 250a and 250b) disposed towards the proximal end 255 of top member 240 in relation to the viewer. Unlike conventional light booths such as that shown in FIG. 1, the inventive light booth of FIG. 2 has a base 230 that comprises a reflective portion 232 that is inclined towards back-plate 220 so as to be substantially orthogonal to back-plate 220. The reflective portion 232 can be made of any material capable of reflecting incident light having a reflective coefficient in the range of or about 0.5 to 1, preferably a mirror. The reflective portion can either be integral with base 230 or releasably attached to base 230. In this configuration, some light (e.g., 260a and 260b) incident on the base 230 is reflected back towards the lower portion 215b of the back-plate 220 as shown by the arrows. Therefore, some light is effectively rerouted to illuminate the lower portion of the back-plate 220, thereby improving the uniformity of illumination of the back-plate and therefore the reflection copy thereon.

The width of the reflector and the angle formed by the reflector coupled to the back-plate relative to the length of the back-plate and the distance of the light sources from the back-plate, all affect the amount of light reflected onto the back-panel and the reflection copy disposed thereon. The most significant dimension to affect the amount of light reflected onto the back-panel is the angle formed by the intersection of the geometrical plane of the reflector and the geometrical plane of the back-plate. Too great an angle of the reflector and the back-plate relative to the iterated dimensions, and minimal light will reflect back onto the reflection copy surface so as not to sufficiently increase the brightness of the bottom portion of the back-plate. Too little an angle of the reflector and the back-plate relative to the additional dimensions will result in a heavy band of light formed on the lower portion of the back-plate close to the mirror.

The preferred embodiment of the light booth of the present invention comprises the following dimensions. Generally with reference to FIG. 2, the angle formed by the intersection of the geometrical plane of the back-plate 220 and the geometrical plane of the top member 240 forms an angle in the range of or about 82° to 86°. The angle formed by the intersection of the geometrical plane of the reflective portion 232 of the base and the geometrical plane of the back-plate 220 forms an angle in the range of or about 88° to 92°. The angle formed by the intersection of the optical axis ray 260a of the light source 250a nearest the back-plate 220 and the proximal edge 231 of the reflective portion 232 of the base 230 forms an angle of or about 102° to 112°. The angle formed by the intersection of the optical axis light ray 260b of the light source 250b furthest from the back-plate 220 and the proximal edge 231 of the reflective portion 232 of the base 230 forms an angle in the range of or about 108° to 120°. The angle formed by the intersection of the optical axis ray 260a of the light source 260a closest to the back-plate 220 forms an angle at the proximal edge 231 of the reflective portion 232 of the base 230 with the optical axis ray 260b of the light source 250b furthest away from the back-plate 220 in the range of or about 3° to 9°.

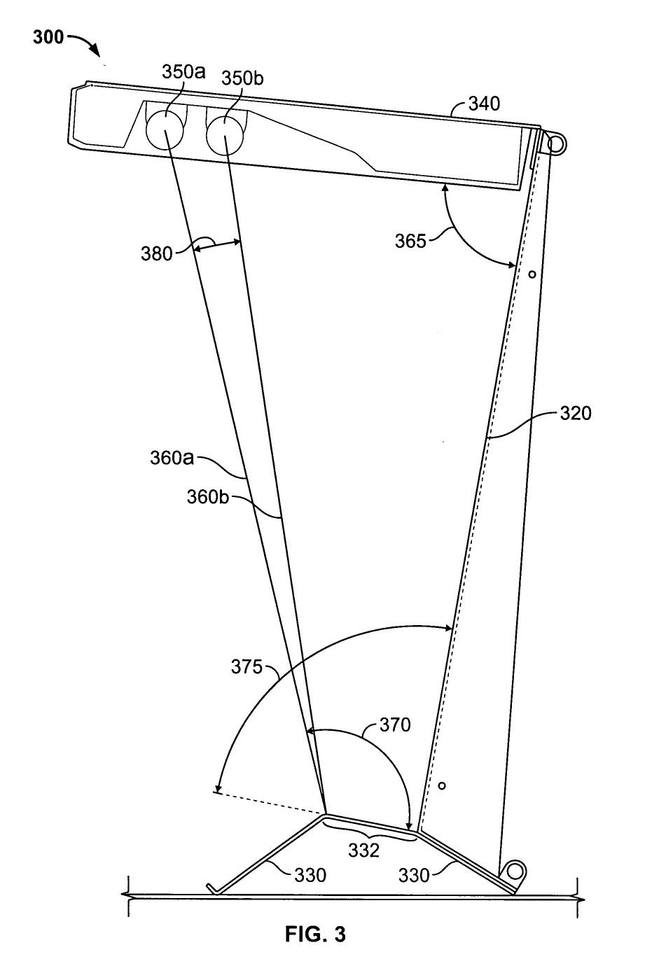

The International Standards Organization (ISO) Specification 3664 defines the optimal viewing-conditions for graphical technology and photography and specifically establishes the luminance levels for reflection copies. According to ISO 3664, any departures from complete uniformity should gradually diminish from the center of the viewing surface to the edge. ISO 3664 further dictates that with respect to viewing areas less than or equal to 1 meter square, the luminance at any point within the square shall not be less than 75% of the luminance measured at the center of the illuminated viewing surface. For larger viewing areas, the ISO 3664 specification indicates that the limit shall not be less than 60%. FIGS. 3, 4, 5, and 6 show exemplary light booths having dimensions for ensuring maximum results of light evenness to illuminate a reflection copy in accordance with the requirements of ISO 3664.

FIG. 3 shows one embodiment of the inventive light booth having dimensions that effectuate a uniform illumination of the back-panel and therefore of a reflection copy disposed thereon. Light booth 300 comprises an inclined back-plate 320 of a length of or about 35 cm which has a top member 340 of a length of or about 33.3 cm mounted thereupon to form an angle 365 of or about (+or −2) 84°. Base 330 has a reflective portion 332 of a width of or about 5.6 cm coupled to back-plate 320 to form an angle 375 of or about (+or −2) 90°. Light source 350a as the furthest light source from the back-plate 320 is disposed in the top member 340 at a distance from the back-plane 320 such that an optical axis light ray 360a of the light emitted from the light source 350a forms an incident angle 370 with the proximal edge 365 of the reflective portion 332 of or about (+or −4) 116°. This angle 370 indicates the widest angle that can be formed by the disposal of an overhead light source in top member 340 at a distance from back-plate 320 such that light can be properly reflected on the back-plate 320 without being wasted as spill light in this embodiment. The second light source 350b is disposed in the top member 340 such that the optical axis ray 360b of this second light source 350b forms an angle 380 at the proximal edge 365 of the reflective portion 332 with the optical axis ray 360a of the first light source 350a of or about (+or −2) 6.5°. This second angle 380 determines the closest distance to the back-plate 320 an overhead light source can be disposed in top member 340 such that the light can be properly reflected on the back plate 320 without creating a band of light on the lower portion 315b of back-plate 320 close to the reflective portion 332 in this embodiment.

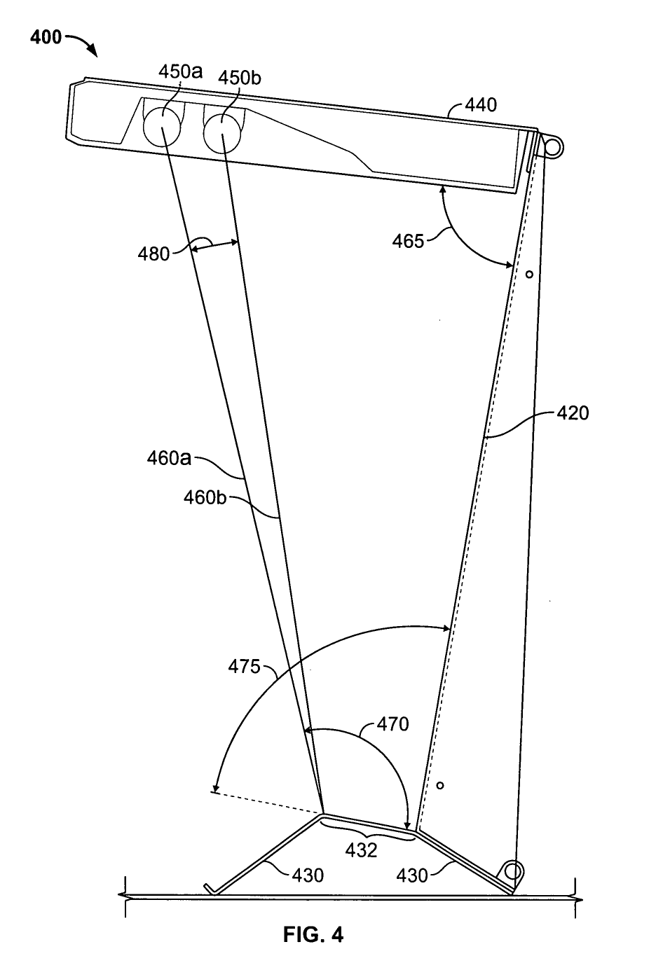

FIG. 4 shows another embodiment of the inventive light booth having dimensions that effectuate a uniform illumination of the back-panel and therefore of a reflection copy disposed thereon. Light booth 400 comprises an inclined back-plate 420 of a length of or about 31.8 cm which has a top member 440 of a length of or about 26.6 cm mounted thereupon to form an angle 465 of or about (+or −2) 84°. Base 430 has a reflective portion 432 of a width of or about 4.3 cm coupled to back-plate 420 to form an angle 475 of or about (+or −2) 90°. Light source 450a as the furthest light source from the back-plate 420 is disposed in the top member 440 at a distance from the back-plane 420 such that an optical axis light ray 460a of the light emitted from the light source 450a forms an incident angle 470 with the proximal edge 465 of the reflective portion 432 of or about (+or −4) 115°. This angle 470 indicates the widest angle that can be formed by the disposal of an overhead light source in top member 440 at a distance from back-plate 420 such that light can be properly reflected on the back-plate 420 without being wasted as spill light in this embodiment. The second light source 450b is disposed in the top member 440 such that the optical axis ray 460b of this second light source 450b forms an angle 480 at the proximal edge 465 of the reflective portion 432 with the optical axis ray 460a of the first light source 450a of or about (+or −2) 7°. This second angle 480 defines the closest distance to the back-plate 420 an overhead light source can be disposed in top member 440 such that the light can be properly reflected on the back plate 420 without creating a band of light on the lower portion 475 of back-plate 420 close to the reflective portion 432 in this embodiment.

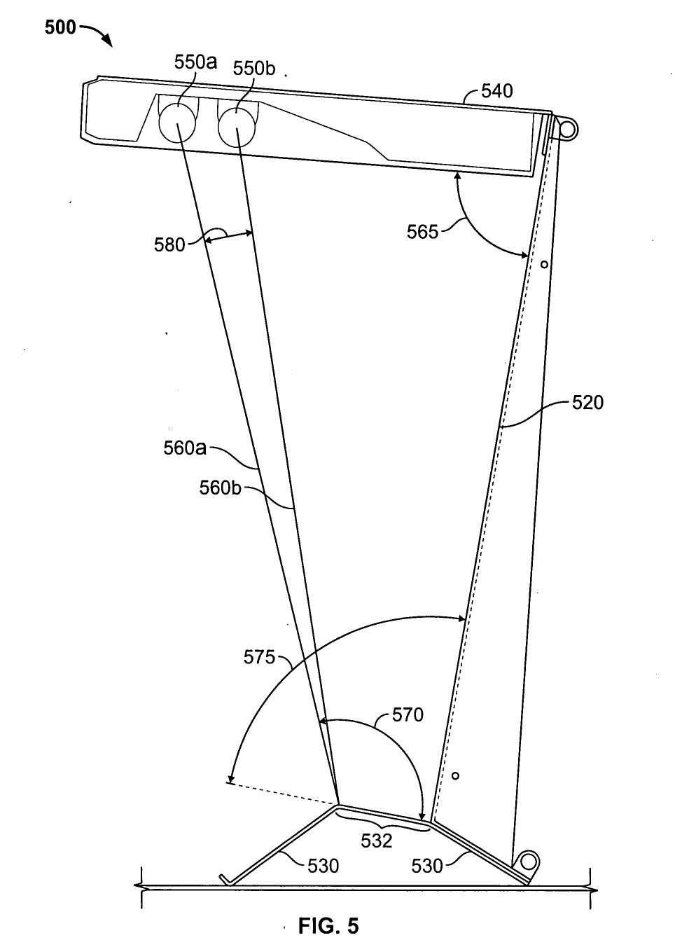

FIG. 5 shows an additional embodiment of the inventive light booth having dimensions that effectuate a uniform illumination of the back-panel and therefore of a reflection copy disposed thereon. Light booth 500 comprises an inclined back-plate 520 of a length of or about 43.8 cm which has a top member 540 of a length of or about 33.3 cm mounted thereupon to form an angle 565 of or about (+or −2) 84°. Base 530 has a reflective portion 532 of a width of or about 6.4 cm coupled to back-plate 520 to form an angle 575 of or about (+or −2) 90°. Light source 550a as the furthest light source from the back-plate 520 is disposed in the top member 540 at a distance from the back-plane 520 such that an optical axis light ray 560a of the light emitted from the light source 550a forms an incident angle 570 with the proximal edge 565 of the reflective portion 532 of or about (+or −4) 114°. This angle 570 indicates the widest angle that can be formed by the disposal of an overhead light source in top member 540 at a distance from back-plate 520 such that light can be properly reflected on the back-plate 520 without being wasted as spill light in this embodiment. The second light source 550b is disposed in the top member 540 such that the optical axis ray 560b of this second light source 550b forms an angle 580 at the proximal edge 565 of the reflective portion 532 with the optical axis ray 560a of the first light source 550a of or about (+or −2) 5°. This second angle 580 determines the closest distance to the back-plate 520 an overhead light source can be disposed in top member 540 such that the light can be properly reflected on the back plate 520 without creating a band of light on the lower portion 515b of back-plate 520 close to the reflective portion 532 in this embodiment.

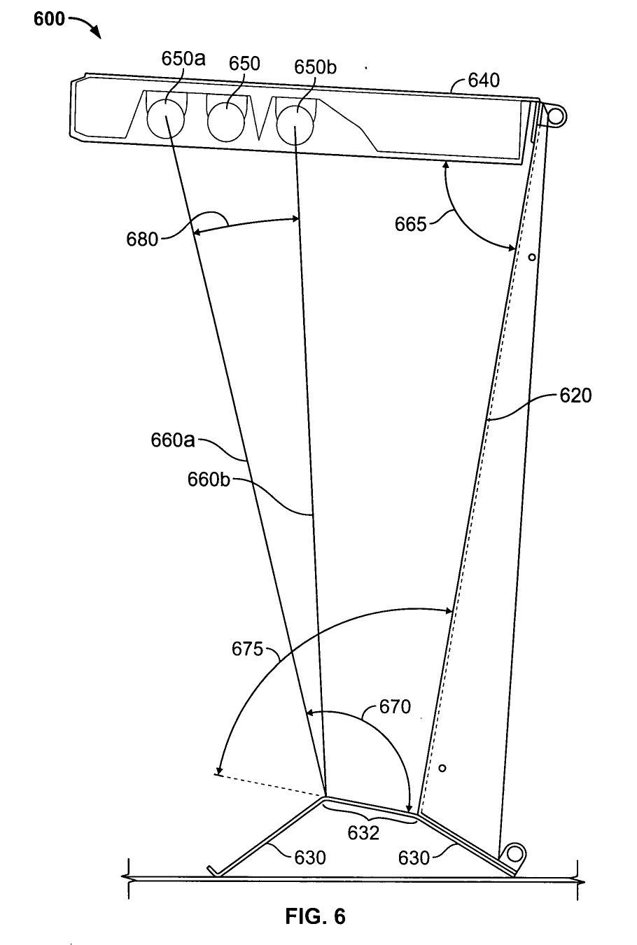

FIG. 6 shows an additional embodiment of the inventive light booth having dimensions that effectuate a uniform illumination of the back-panel and therefore of a reflection copy disposed thereon. Light booth 600 comprises an inclined back-plate 620 of a length of or about 61.6 cm which has a top member 640 of a length of or about 40.6 cm mounted thereupon to form an angle 665 of or about (+or −2) 84°. Base 630 has a reflective portion 632 of a width of or about 7.6 cm coupled to back-plate 620 to form an angle 675 of or about (+or −2) 90°. Light source 650a as the furthest light source from the back-plate 620 is disposed in the top member 640 at a distance from the back-plate 620 such that an optical axis light ray 660a of the light emitted from the light source 650a forms an incident angle 670 with the proximal edge 665 of the reflective surface 632 of or about (+or −4) 112°. This angle 670 indicates the widest angle that can be formed by the disposal of an overhead light source in top member 640 at a distance from back-plate 620 such that light can be properly reflected on the back-plate 620 without being wasted as spill light in this embodiment. The second light source 650b is disposed in the top member 640 such that the optical axis ray 660b of this second light source 650b forms an angle 680 at the proximal edge 665 of the reflective portion 632 with the optical axis ray 660a of the first light source 650a of or about (+or −2) 8°. This second angle 680 determines the closest distance to the back-plate 620 an overhead light source can be disposed in top member 640 such that the light can be properly reflected on the back plate 620 without creating a band of light on the lower portion 675 of back-plate 620 close to the reflective surface 632 in this embodiment.

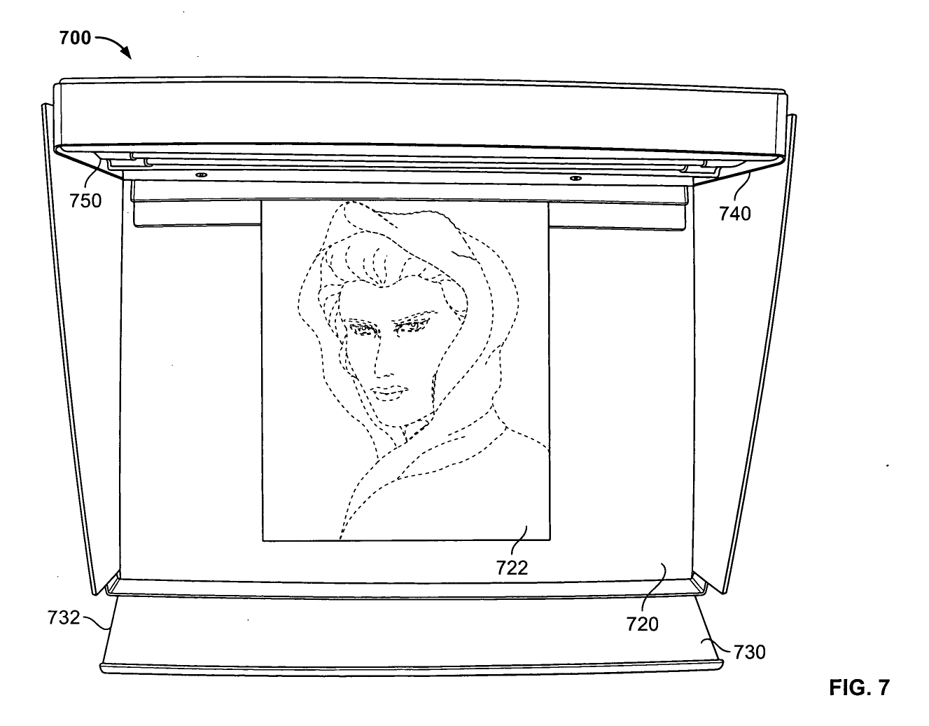

FIG. 7 shows a frontal view of a particularly preferred embodiment of the present invention. Light booth 700 comprises an inclined back-plate 720 which is mounted on a base 730. A top member 740 houses one or more light sources (shown as 750a and 750b) disposed at the proximal end of top member 740 in relation to the viewer. Base 730 comprises a reflective portion 732 that is inclined towards back-plate 720 so as to be substantially orthogonal to back-plate 720. The reflective portion 732 is preferably a mirror either integral with base 730 or releasably attached to base 730. In this configuration, some light incident on the reflector 732 is reflected back towards the lower portion of the back-plate 720 and is thus effectively rerouted to illuminate the lower portion of the back-plate 720, thereby improving the uniformity of illumination of the back-plate and therefore the reflection copy 722 thereon.

Charts I-IV below illustrate the improvement in overall luminance uniformity of the above-described light booth embodiments of the present invention. Using a Minolta LS-100 luminance meter, luminance measurements were taken at pre-selected bottom intervals, and pre-selected top intervals of the embodiments of the inventive light booth and conventional light booths of the same size. The measurements at the top were taken at the center of the viewing area and 14 cm down from the top of the viewing area. The measurements at the bottom were taken at the center of the viewing area and 14 cm up from the bottom. The comparative data showing the improvement in uniformity of the exemplary embodiments of the present invention is presented in the following charts.

CHART I
(LIGHT BOOTH 200)

| | LIGHT BOOTH | LIGHT BOOTH |
|---|---|---|
| LUMINANCE MEASUREMENT | 181 fL | 181 fL |
| TOP OF BACK-PLATE | | |
| LUMINANCE MEASUREMENT | 68 fL | 106 fL |
| BOTTOM OF BACK-PLATE | | |

In the conventional light booth the illumination difference between the top of the back-plate and the bottom of the back-plate is 113 foot-Lamberts (fL). In inventive light booth 200, on the other hand, the illumination difference between the top of the back-plate and the bottom of the back-plate has been reduced to 75 fL, resulting in a 27.5% improvement in the overall uniformity of luminance (calculated from center measurement).

CHART II
(LIGHT BOOTH 400)

| | | LIGHT BOOTH |
|---|---|---|
| | LIGHT BOOTH | 400 |
| LUMINANCE MEASUREMENT | 217 fL | 217 fL |
| TOP OF BACK-PLATE | | |
| LUMINANCE MEASUREMENT | 60 fL | 98 fL |
| BOTTOM OF BACK-PLATE | | |

In the conventional light booth the illumination difference between the top of the back-plate and the bottom of the back-plate is 157 fL. In inventive light booth 200, on the other hand, the illumination difference between the top of the back-plate and the bottom of the back-plate has been reduced to 119 fL, resulting in a 23.4% improvement in the overall uniformity of luminance (calculated from center measurement).

CHART III
(LIGHT BOOTH 500)

| | | LIGHT BOOTH |
|---|---|---|
| | LIGHT BOOTH | 500 |
| LUMINANCE MEASUREMENT | 220 fL | 220 fL |
| TOP OF BACK-PLATE | | |
| LUMINANCE MEASUREMENT | 57 fL | 85 fL |
| BOTTOM OF BACK-PLATE | | |

In the conventional light booth the illumination difference between the top of the back-plate and the bottom of the back-plate is 163 fL. In inventive light booth 200, on the other hand, the illumination difference between the top of the back-plate and the bottom of the back-plate has been reduced to 135 fL resulting in a 19.8% improvement in the overall uniformity of luminance(calculated from center measurement).

CHART IV
(LIGHT BOOTH 600)

| | | LIGHT BOOTH |
|---|---|---|
| | LIGHT BOOTH | 600 |
| LUMINANCE MEASUREMENT | 190 fL | 190 fL |
| TOP OF BACK-PLATE | | |
| LUMINANCE MEASUREMENT | 42 fL | 73 fL |
| BOTTOM OF BACK-PLATE | | |

In the conventional light booth the illumination difference between the top of the back-plate and the bottom of the back-plate is 148 fL. In inventive light booth 200, on the other hand, the illumination difference between the top of the back-plate and the bottom of the back-plate has been reduced to 117 fL, resulting in a 23.0% improvement in the overall uniformity of luminance (calculated from center measurement).

As demonstrated by the charts above, the uniformity of the luminance is greatly improved in the light booth embodiments of the present invention, solving the need in the art for light booths which overcome the deficiencies of the prior art by providing substantially uniform light intensity across the surface of the back-plate and thus across the reflection copy image disposed thereupon.

Although the present invention has been described in considerable detail with reference to certain preferred versions thereof, other versions are possible. Therefore, the spirit and scope of the appended claims should not be limited to the description of the embodiments herein.

What is claimed is:

1. A light booth comprising:
a back-plate for supporting a reflection copy;
a top member having a proximal end and a distal end wherein said proximal end is coupled to said upper end of said back-plate to form an angle in the range of or about 82 to 86 degrees;
a base comprising a reflective portion; wherein said reflective portion has a proximal end, a distal end, and a width dimension; wherein said proximal end is coupled to said lower end of said back-plate to form an angle in the range of or about 88 to 92 degrees;
a first and second overhead light disposed in said top member for illuminating said back-plate; said first and second overhead light disposed such that each optical axis of light incident to the proximal end of said reflective portion has an angle dimension relative to said width dimension sufficient to reflect incident light rays towards a bottom portion of said back-plate, thereby increasing the intensity of light on said bottom portion and improving the overall uniformity of illumination of said back-plate.

2. The light booth of claim 1, wherein said back-plate has a length of or about 35 cm; wherein said width of said reflective portion is about 6 cm; and wherein said optical axis of said first light source has an angle dimension of or about 116 degrees; and wherein said second light source is disposed such that its optical axis forms an angle with said first optical axis of or about 6.5 degrees.

3. The light booth of claim 1, wherein said back-plate has a length of or about 32 cm; wherein said width of said reflective portion is about 5 cm; and wherein said optical axis of said first light source has an angle dimension of or about 115 degrees; and wherein said second light source is disposed such that its optical axis forms an angle with said first optical axis of or about 7 degrees.

4. The light booth of claim 1, wherein said back-plate has a length of or about 62 cm; wherein said width of said reflective portion is about 8 cm; and wherein said optical axis of said first light source has an angle dimension of or about 112 degrees; and wherein said second light source is disposed such that its optical axis forms an angle with said first optical axis of or about 8 degrees.

5. The light booth of claim 1, wherein said back-plate has a length of or about 44 cm; wherein said width of said reflective portion is about 7 cm; and wherein said optical axis of said first light source has an angle dimension of or about 114 degrees; and wherein said second light source is disposed such that its optical axis forms an angle with said first optical axis of or about 8 degrees.

6. The light booth of claim 1, wherein said reflective portion comprises a mirror.

7. A light booth comprising:
a back-plate against which a reflection copy image is disposed for viewing;
at least one overhead light disposed in a top member of said light booth;
a reflector at a base of said back-plate configured to reflect incident light at the lower portion of said back-plate thereby improving the uniformity of illumination of said back-plate and consequently of said reflection copy disposed thereon.

8. The light booth of claim 7 wherein said reflector is a mirror.
